(19) United States
(12) Patent Application Publication
(10) Pub. No.: US 2015/0086682 A1
(43) Pub. Date: Mar. 26, 2015

(54) METHOD FOR MANUFACTURING EDIBLE TRANSPARENT MATERIALS THAT CAN BE USED AS CONTAINERS FOR FOOD PRODUCTS, AND USES THEREOF

(71) Applicant: Hassouna Bouaziz, Viroflay (FR)

(72) Inventor: Hassouna Bouaziz, Viroflay (FR)

(21) Appl. No.: 14/239,640

(22) PCT Filed: Aug. 28, 2012
(86) PCT No.: PCT/IB2012/054403

§ 371 Date: Apr. 11, 2014

(30) Foreign Application Priority Data
Aug. 30, 2011 (FR) 11/57645

(51) Int. Cl. A23G 3/34; A23G 3/42; A23G 3/54

(52) U.S. Cl. CPC A23G 3/0053; A23G 3/545; A23G 3/42
USPC 426/138; 426/390

(57) ABSTRACT

The invention relates to a method for producing a food material essentially consisting of isomalt, characterised in that it includes the steps of extruding and melting the material by raising the temperature to 80° C. to 160° C., preferably 150° C. to 160° C., tempering so as to obtain the material in the stable crystalline form thereof and to eliminate bubbles in the material, and pouring or injecting into moulds. Application of the material obtained as a container.

The invention concerns a method for manufacturing edible transparent materials for covering, packaging or supporting food products, thus constituting containers for these products.

Most present-day packaging, with the notable exception of ice cream cones and tart bases, is disposable and therefore polluting. It is most generally a question of plastic materials, cardboard, paper or glass, and this has the disadvantage of imposing management constraints as much at the level of hygiene as at that of breakages.

The inventor's research has been oriented toward a material essentially consisting of isomalt, the qualities of which meet the required criteria for the envisaged applications. Isomalt is a 50/50 mixture of two substances, 1,6-glucopyranosyl-D-sorbitol and 1,1-glucopyranosyl-D-mannitol. It is synthesised from sucrose. It is marketed in a wide range of particle sizes (Fritzsching, B., 1993, Isomalt, a sugar substitute ideal for the manufacture of sugar-free and calorie-reduced confectionery. In: Conference Proceedings-Food Ingredients Europe. Maarssen, the Netherlands, pp. 371-377): type M (90% of particles: 0.50-3.5 mm), type F (90%: 200-700 μm), type C (90%<400 μm) and type PF (90%<100 μm). During the crystallisation process, GPM crystallises with two water molecules whereas GPS crystallises in an anhydrous form and consequently isomalt contains approximately 5% water of crystallisation.

This material is commonly used in foods, notably to decorate pastries. It notably has the advantage of a moderately sweet taste, great stability in alkaline or acid media, low hygroscopy and high resistance to heat treatment, remaining transparent even after heating, which makes it possible to manufacture items with the appearance of glass.

It is however the case that applications such as containers demand a product of high quality, that is transparent, with no bubbles in the material, and that has a uniform visual appearance, which leads to manufacturing constraints.

The research carried out has made it possible to develop conditions enabling the automatic and reproducible provision of a material in shapes adapted to serve as containers of the most diverse food products.

An object of the invention is therefore to provide a method for the automatic production of a food material essentially consisting of isomalt.

It is also aimed at the production of a new generation of food packaging or covering materials, available in different configurations, which makes it possible to make available a wide range of supports, in particular of small size for use in various agriculture-foodstuffs sectors and enabling immediate and detailed viewing (for example presence of fruit, inclusions, colour) at the same time as preserving crispness.

The method in accordance with the invention of producing a food material essentially consisting of isomalt is characterised in that it comprises the steps of:
extruding and melting the material by raising the temperature to 80° C. to 160° C., preferably 150° C. to 160° C.,
tempering so as to obtain the material in the stable crystalline form thereof, to eliminate bubbles in the material, and to cool the material obtained in a controlled manner, and
pouring or injection into moulds.

The melting step is more particularly carried out in a cooking vat (large cooking pot) or in an extruder. The heating time is notably from at least 2 minutes to around ten minutes.

In the case of melting in an extruder, bubbles in the material introduced are advantageously eliminated by the pressure inside the extruder and the subsequent expansion and its temperature is uniform.

Tempering is effected at a temperature higher than the melting temperature but enabling the product to remain malleable and ductile.

Forming is carried out at a temperature higher than the glass transition temperature of isomalt, which is 40° C., notably at 80° C. to 95° C. by thermoforming by injection, after passing through the die and cropping by injection or simply by pouring into moulds having the required shape for the envisaged application, the forming step being carried out at a constant temperature so that the material treated has a uniform water content and crystallinity. The above temperatures enable working in the liquid state, without high viscosity.

Particularly preferred conditions that prevent the formation of a large quantity of bubbles and browning of the product comprise:
a heating temperature of 160° C.,
a heating time of 3 minutes, and
a cooling temperature of 120° C.-130° C.

The method defined above advantageously also includes a glazing step including evaporation of a food glaze, in particular one that is colourless, such as shellac gum, in a tunnel of the extruder to protect the material from moisture. The material must be returned to room temperature in order to ensure that the isomalt-based material remains stable and is not fragile.

In one embodiment of the invention, the material used is flavoured and/or coloured isomalt.

Separately or in combination, the features defined above enable a material to be obtained in different configurations and different sizes. The method of the invention notably enables production of small (“mini”) packaging having the advantage of adding value to the contents thanks to its transparency. Moreover, the packaging material is biodegradable.

This material is particularly suitable for receiving all kinds of filling, cold or frozen, savoury or sweet. It can thus serve as packaging used by caterers and pastry makers, by ice cream makers and the frozen food industry, by cooks and restaurateurs, for presentation in various forms and sizes leaving free rein to creativity, notably in the form of verrines, canapés and nibbles, cups, wineglasses, cones, in particular mini-cones, caterers' trays, small boxes, and for wide distribution for individual use. The containers may be of varying shape, including oval and lozenge shapes. In the ice cream industry, a practical product is for covering ice lollies. Freezing trials have shown satisfactory behaviour of the material at low temperatures. Value is added to the contents by the transparency of the packaging.

The invention is therefore also aimed at a container for food products obtained by the method defined above.

In addition to the utilitarian aspect, the material used in accordance with the invention advantageously adds value to the contained product. The product, its structure and its colour are immediately visible.

Other features and advantages of the invention are set out in the following illustrative example.

### EXAMPLE

The starting material used is isomalt in the form of solid balls.

### Physical and Chemical Characteristics of Isomalt

| | |
|---|---|
| Commercial form | di-hydrated |
| Molecular weight (g/mol) | 355 |
| Sweetening power | 0.5 |
| Available energy (kcal/g) | 2 |
| Solubility in water (%), at 20° C. | 25 |
| Solubility in water (%), at 50° C. | 55 |
| Browning on heating | Slight |
| Stable in pH range | 2-9 |
| Dissolution enthalpy(cal/g, at 25° C.) | −9.4 |
| Sensation in the mouth | Freshness |

The sweetening power of isomalt is half that of saccharose (sucrose). It is advantageously a low-calorie product (2 kcal/g). Its solubility in water depends greatly on temperature. Unlike the saccharose from which it is obtained (synthesis of isomalt), it caramelises (browns) little during intense heating. Moreover, it is stable at pH values typical of foods.

In the example given, the isomalt balls are liquefied by melting:
in a cooking vat (large cooking pot) with the temperature increased to 150° C.-160° C.,
in an extruder: the balls are introduced continuously and heated to 150° C.-160° C. One or two lead screws drive the molten mass to the die.

The product is then subjected to shear and to a high pressure, enabling elimination of bubbles.

Before forming, the molten material undergoes a tempering step that enables the material to be obtained in its stable form and bubbles to be eliminated if melting was effected in an extruder or the elimination of bubbles to be perfected when extrusion has been employed.

This phase of hot extrusion of isomalt enables a product to be obtained having a uniform exit temperature. Thanks to the pressure inside the extruder and the subsequent expansion, the elimination of bubbles from the material obtained is satisfactory.

Thermoforming takes place after passing through the die, which is followed by cropping. These operations may also be effected simultaneously.

Alternatively, melted isomalt is worked by injection, which implies control of the temperature during injection into the mould to prevent different crystallinities and different water contents.

Thus the invention provides a technique for obtaining an innovative isomalt-based product particularly appropriate for supporting/packaging/covering a great variety of food preparations.

1. Method for producing a food material essentially consisting of isomalt, characterised in that it includes the steps of:
extruding and melting the material by raising the temperature to 80° C. to 160° C., preferably 150° C. to 160° C.,
tempering so as to obtain the material in the stable crystalline form thereof and to eliminate bubbles in the material, and
pouring or injection into moulds.

2. Method according to claim 1, characterised in that the melting step is carried out in a cooking vat or in an extruder.

3. Method according to claim 2, characterised in that the heating time is from 2 to 10 minutes.

4. Method according to claim 2, characterised in that, in the case of melting in an extruder, bubbles are eliminated from the material introduced thanks to the pressure inside the extruder and the subsequent expansion.

5. Method according to claim 1, characterised in that tempering is effected at a temperature higher than the melting temperature but enabling the product to remain malleable and ductile.

6. Method according to claim 1, characterised in that forming is carried out at a temperature higher than the glass transition temperature of isomalt, which is 40° C., by thermoforming by injection, after passing through the die and cropping, or simply by pouring into moulds having the required shape for the envisaged application, the forming step being carried out at a constant temperature so that the treated material has a uniform water content and crystallinity.

7. Method according to claim 6, characterised in that forming is carried out at a temperature of 80° C. to 95° C.

8. Method according to claim 1, characterised in that it also includes a glazing step by evaporation of a food glaze, in particular one that is colourless, such as shellac gum, in a tunnel of the extruder.

9. Method according to claim 1, characterised in that the food material essentially consisting of isomalt is flavoured and/or coloured.

10. Method according to claim 1, characterised in that the material obtained is used as a container for any kind of filling, cold or frozen, savoury or sweet.

11. Container for food products obtained by the method according to claim 1.

12. Container according to claim 11, in the form of verrines, canapes and nibbles, cups, cones, wineglasses, caterers' trays, small boxes.

13. Application of the container according to claim 11, by caterers and pastry makers, ice cream makers and the frozen food industry, restaurateurs.
